(19) United States
(12) Patent Application Publication
(10) Pub. No.: US 2026/0189482 A1
(43) Pub. Date: Jul. 2, 2026

(54) RISK FORECASTING IN A WIRELESS NETWORK

(71) Applicant: Lenovo (United States) Inc., Morrisville, NC (US)

(72) Inventors: Lucileide Medeiros Dantas da Silva, Natal (BR); Sergio Natan Silva, Candelária (BR); Marcelo Augusto Costa Fernandes, Natal (BR); Augusto José Venâncio Neto, Natal (BR); Vicente Angelo de Sousa, JR., Natal (BR); Marcos Rogério Salvador, Americana (BR); Ramon dos Reis Fontes, Rio Grande do Norte (BR); Guilherme Magalhaes Pupio, Sao Jose dos Campos (BR)

(73) Assignee: Lenovo (United States) Inc., Morrisville, NC (US)

(21) Appl. No.: 19/005,602

(22) Filed: Dec. 30, 2024

(51) Int. Cl. H04L 41/5009; H04L 41/149; H04L 41/16

(52) U.S. Cl. CPC H04L 41/5009; H04L 41/149; H04L 41/16

(57) ABSTRACT

Various aspects of the present disclosure relate to risk forecasting in a wireless network. A network equipment (NE) implements a risk forecasting function that receives multiple series of key performance indicator (KPI) values over a time duration. Each series of the KPI values correspond to a respective KPI that is a performance metric of a network aspect. The risk forecasting function generates a KPI representation based on a predicted KPI value and one or more previous KPI values of the respective KPI. The risk forecasting function generates a forecast embedded matrix (FEM) that includes the KPI representations of each KPI. The risk forecasting function detects whether a change has occurred between the FEM and one or more previous FEMs over the time duration.

### TECHNICAL FIELD

The present disclosure relates to wireless communications, and more specifically to risk forecasting in a wireless network.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

The wireless communications system may support wireless communications, and may include one or more devices, such as UEs, base stations (e.g., gNBs), network entities, satellites, and/or network equipment (NE), among other devices, that transmit and/or receive signaling. In a wireless communications system, open RAN is an evolution of the next generation radio access network (NG-RAN) architecture, and may support various features for disaggregated deployment of mobile fronthaul and midhaul networks. Open RAN is intended to support interoperation between different wireless network equipment and devices for flexibility and interoperability in a wireless communications system, such as by use of open interfaces.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may include a NE for wireless communication. The NE implements a risk forecasting function and may be configured or operable to perform one or more operations as described herein. For example, the NE may be configured or operable to receive multiple series of key performance indicator (KPI) values over a time duration, where each series of the KPI values correspond to a respective KPI that is a performance metric of a network aspect; generate a KPI representation based at least in part on a predicted KPI value and one or more previous KPI values of the respective KPI, wherein a forecast embedded matrix (FEM) includes the KPI representations of each KPI; and detect whether a change has occurred between the FEM and one or more previous FEMs over the time duration.

Some implementations of the method and apparatuses described herein may include a processor (e.g., a standalone processor chipset, or a component of a NE) for wireless communication. The processor may be configured or operable to perform one or more operations as described herein. For example, the processor may be configured or operable to receive multiple series of KPI values over a time duration, each series of the KPI values corresponding to a respective KPI that is a performance metric of a network aspect; generate a KPI representation based at least in part on a predicted KPI value and one or more previous KPI values of the respective KPI, wherein a FEM includes the KPI representations of each KPI; and detect whether a change has occurred between the FEM and one or more previous FEMs over the time duration.

Some implementations of the method and apparatuses described herein may further include a method performed or performable by a NE that implements a risk forecasting function. For example, the method may include receiving multiple series of KPI values over a time duration, each series of the KPI values corresponding to a respective KPI that is a performance metric of a network aspect; generating a KPI representation based at least in part on a predicted KPI value and one or more previous KPI values of the respective KPI, wherein a FEM includes the KPI representations of each KPI; and detecting whether a change has occurred between the FEM and one or more previous FEMs over the time duration.

In some implementations of the NE, the processor, and the method described herein, the NE, the processor, and the method may further be configured or operable to cause a future shift embedding (FSE) of the risk forecasting function to forecast predicted KPI values of respective KPIs based at least in part on the series of KPI values received over the time duration; generate the KPI representations of the respective KPIs; and generate the FEM of the KPI representations.

In some implementations of the NE, the processor, and the method described herein, the NE, the processor, and the method may further be configured or operable to cause a matrix time scan (MTS) of the risk forecasting function to detect at least one of a similarity or a dissimilarity as the change between the FEM and the one or more previous FEMs over the time duration.

In some implementations of the NE, the processor, and the method described herein, the NE, the processor, and the method may further be configured or operable to cause the risk forecasting function to utilize machine learning to detect the at least one of the similarity or the dissimilarity as the change between the FEM and the one or more previous FEMs over the time duration.

In some implementations of the NE, the processor, and the method described herein, the dissimilarity between the FEM and the one or more previous FEMs forecasts a failure prediction of the network aspect. In some implementations of the NE, the processor, and the method described herein, the dissimilarity between the FEM and the one or more previous FEMs forecasts an evolving trend in a performance of the network aspect.

In some implementations of the NE, the processor, and the method described herein, the NE, the processor, and the method may further be configured or operable to cause the MTS to normalize at least one of a similarity metric or a dissimilarity metric; and generate a change rating as a normalized value of one of the similarity metric, the dissimilarity metric, or as the normalized value in a range between the similarity metric and the dissimilarity metric.

In some implementations of the NE, the processor, and the method described herein, the normalized value is one of a zero indicating at least one of no change or a relatively low level of a change between the FEM and the one or more previous FEMs; a one indicating a relatively high level of a change between the FEM and the one or more previous FEMs; or between the zero and the one indicating at least the change between the FEM and the one or more previous FEMs.

### BRIEF DESCRIPTION OF THE DRAWINGS

FIG. 1 illustrates an example of a wireless communications system in accordance with aspects of the present disclosure.

FIG. 2 illustrates an example of an open RAN system in accordance with aspects of the present disclosure.

FIG. 3 illustrates an example risk forecasting system in accordance with aspects of the present disclosure.

FIG. 4 illustrates an example of FSE in the risk forecasting system, in accordance with aspects of the present disclosure.

FIG. 5 illustrates an example of a matrix time scan (MTS) in the risk forecasting system, in accordance with aspects of the present disclosure.

FIG. 6 illustrates an example of risk evaluation in the risk forecasting system, in accordance with aspects of the present disclosure.

FIG. 7 illustrates an example signal diagram of components of a risk forecasting function, module, or system in accordance with aspects of the present disclosure.

FIG. 8 illustrates an example of a NE in accordance with aspects of the present disclosure.

FIG. 9 illustrates an example of a processor in accordance with aspects of the present disclosure.

FIG. 10 illustrates a flowchart of a method performed by a NE that implements a risk forecasting function in accordance with aspects of the present disclosure.

FIG. 11 illustrates a flowchart of a method performed by a NE that implements a risk forecasting function in accordance with aspects of the present disclosure.

### DETAILED DESCRIPTION

A wireless communications system may include aspects of the Open RAN 5G architecture, which can include aspects of a NR network, such as a 5G network and a radio access network (RAN) intelligent controller (RIC). The RIC can be implemented as a central software component of the Open RAN architecture to control and optimize RAN functions and resources. A first type of RIC may be implemented in service and management orchestration (SMO) in the 3GPP domain, such as centrally on an operator network in the wireless communications system to handle non-real time (non-RT) events. A second type of RIC may be implemented as a near-real time (near-RT) RIC, which operates in the O-RAN domain, such as on a network edge server.

Aspects of network operation, such as in 4G/5G Open RAN networks, depend on software components and their configuration, general processor purpose (GPP) hardware resources, such as for server and software-defined radio (SDR), network availability for public and/or private Internet, security assurances, and environmental conditions. Given the multitude of network aspects and operation, the identification and prevention of disaster events in 4G/5G open RAN networks is a critical challenge in operation and maintenance (O&M). There is also an essential role in maintaining the integrity, performance, and availability of information technology (IT) infrastructures. Disaster events that affect network aspects of operation can result in significant impacts, including service outages, loss of critical data, and compromised security, which may be realized as revenue losses. Accordingly, risk forecasting provides an ability to anticipate disaster events in 4G/5G Open RAN networks by risk evaluation and by forecasting predicted risk events that may affect aspects of network operation.

Aspects of the present disclosure are described in the context of a wireless communications system, and include risk forecasting that may involve an implementation of advanced deep learning techniques (e.g., AI/ML using system information). Aspects of the disclosed risk forecasting is implemented to identify patterns and trends that may indicate the imminent occurrence of disaster events in the network, such as resource overload, network failures, security breaches, and software errors that may alter or affect the stability and effectiveness of these critical systems. Further aspects of the present disclosure includes an associated decision system (also referred to herein as risk evaluation) that calculates risk values, allowing for proactive actions to mitigate or prevent such events, thereby ensuring the continuous and reliable operation of 5G and open RAN networks. In implementations, a risk forecasting function receives or obtains KPI inputs, such as software-dependent KPIs, hardware-dependent KPIs, 5G and RIC KPIs, user-related KPIs (e.g., as related to user satisfaction), environment conditions KPIs (e.g., as related to temperature, humidity, energy stability, etc.).

In aspects of the described techniques, an NE, such as any type of network equipment, network element, network function, network entity, and/or network node in the wireless communications system, implements a disaster event forecasting entity (also referred to herein as a risk forecasting function of a risk forecasting system). The risk forecasting system includes FSE, MTS, and risk evaluation modules, functions, and/or components that are implemented to identify the patterns and trends that may indicate the imminent occurrence of a disaster event in the network. In one or more implementations, the FSE provides for a combination of temporal analysis and embedding for time series forecasting. Notably the FSE combines time series analysis with embedding techniques. While some conventional models focus solely on predicting future values based on historical data, the FSE integrates future forecasts, such as obtained via long short-term memory (LSTM) or similar techniques, and transforms them into embeddings. Accordingly, the FSE not only predicts the future, but also encodes these predictions into a compact and informative format for subsequent analysis. This approach is particularly innovative as it creates a useful representation of data, capturing not just what has happened or will happen, but also the nature of the evolution of these events over time.

In additional aspects of the described techniques, a the FSE is implemented to generate a holistic representation of KPIs through temporal sequence embeddings. The FSE generates the embeddings from data sequences that include both past information and future forecasts, which provides a comprehensive view of the behavior of KPIs over time. This goes beyond point-in-time data analysis, providing a deeper, integrated understanding of how KPIs evolve and interact over time for failure prediction and detection in complex network systems, where gaining a forecast and understanding of long-term KPI trends and patterns can provide for effective mitigation of potential or realized risk events and/or network disaster events.

In additional aspects of the described techniques, the MTS is implemented with the FSE to conduct in-depth evolutionary analysis of KPI temporal trends. In implementations, the MTS leverages the data representation provided by the FSE to analyze how predictions and KPI patterns evolve over time. This approach allows for more than just point-to-point variation analysis in that it enables a detailed representation of how emerging trends and changes in data patterns occur. This is particularly useful for predicting and identifying potential failures or issues in complex network systems, where subtle changes over time can be critical indicators of future problems. Another innovative aspect of the MTS in conjunction with the FSE is an enhanced ability to detect anomalies and emerging patterns. By analyzing the matrices generated by the FSE, the MTS can identify deviations not only in current conditions, but also in predicted future trends. This represents a significant advancement over traditional anomaly detection techniques, which typically focus on historical data. The MTS, with a focus on temporal changes and future predictions, can provide early warnings about unusual events or potentially problematic conditions, allowing for more timely and effective mitigation.

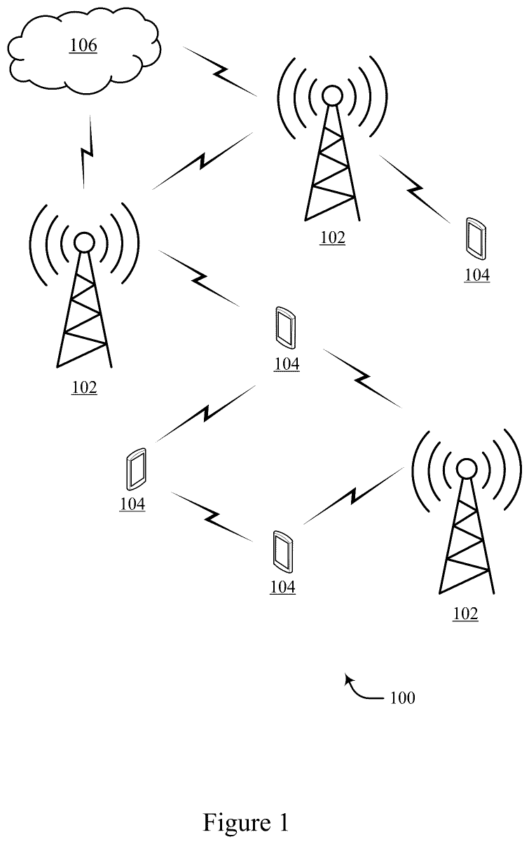

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU 160.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix. A time interval of a resource (e.g., a communication resource) may be organized

according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0,μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

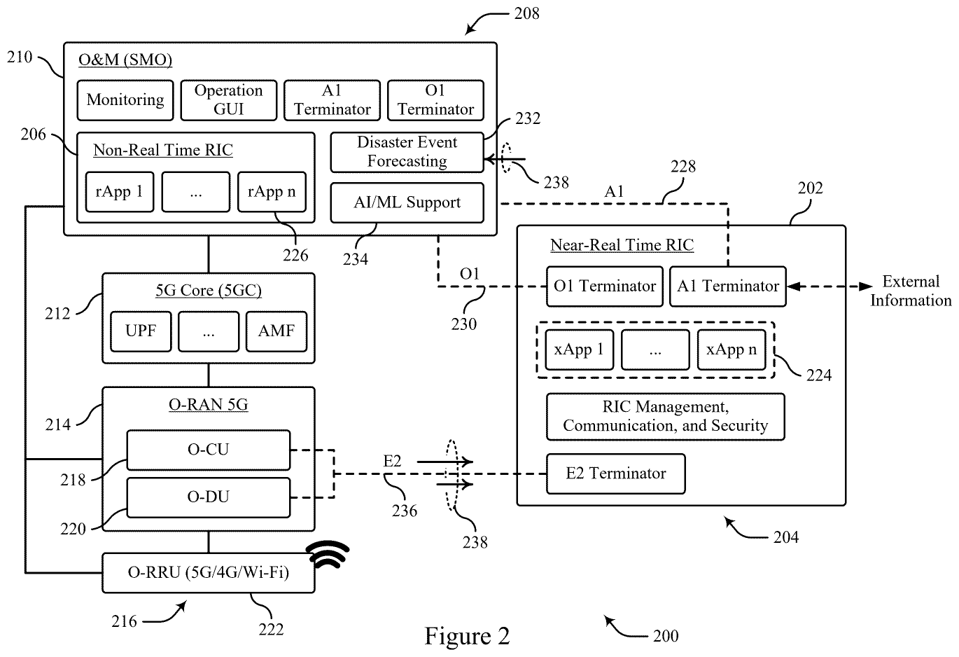

FIG. 2 illustrates an example of an open RAN system 200 in accordance with aspects of the present disclosure. In this example, the system 200 is illustrative of open RAN 5G, which includes aspects of a NR network, such as a 5G network, and a near-real time (RT) radio access network (RAN) intelligent controller (RIC) 202. In the system, an O-RAN domain 204 includes the near-RT RIC 202 and a non-RT RIC 206. The RIC (e.g., the near-RT RIC 202 and non-RT RIC 206) is the central software component of the open RAN system 200, and controls and optimizes RAN functions and resources. Additionally, a 3GPP domain 208 includes operation and maintenance (O&M) 210, such as service and management orchestration (SMO), a 5G core (5GC) 212, and O-RAN 5G 214. Additionally, an O-RAN plus 3GPP domain 216 includes an O-RAN central unit (O-CU) 218 and an O-RAN distributed unit (O-DU) 220 of the O-RAN 5G 214, as well as one or more O-RAN remote radio units (O-RRUs) 222 for 5G, 4G, and/or Wi-Fi.

The near-RT RIC 202 hosts one or more xApps 224 (e.g., xApp 1 . . . xApp n), which are microservice-based applications that process in near-real time to optimize signaling overhead and enhance the RAN efficiency. The non-RT RIC 206 hosts one or more rApps 226 (e.g., rApp 1 . . . rApp n), which are also microservice-based applications. The open RAN system 200 includes operator interfaces, such as the A1 interface 228 and the O1 interface 230, which are interfaces to the non-RT RIC 206 for the management and optimization of the RAN system. The A1 interface 228 supports a communication link between the non-RT RIC 206 implemented in the O&M 210 and the near-RT RIC 202 for RAN optimization. The O1 interface 230 supports connection of the O&M 210 to open RAN network functions.

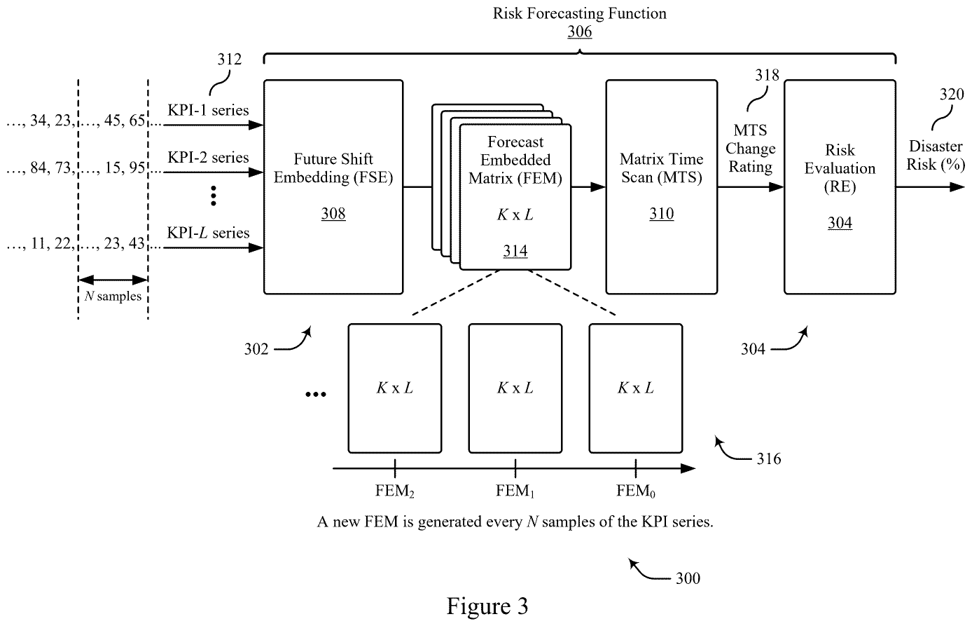

In implementations, an NE (e.g., any type of network equipment, network element, network function, network entity, and/or network node in the wireless communications system) implements the O&M 210 (e.g., SMO), implements a disaster event forecasting entity 232, such as any type of module or function implemented for risk forecasting of network events. Aspects of a risk forecasting system and risk forecasting function are further shown and described with reference to FIGS. 3-6. In further aspects of the techniques described herein, the disaster event forecasting entity 232 may leverage or utilize artificial intelligence (AI)/ machine learning (ML) 234 to evaluate KPIs, and in particular, determine similarity and/or dissimilarity in forecast embedded matrices that include KPI representations of multiple KPIs, such as to determine, identify, or forecast a possible failure prediction in a network aspect and/or forecast an evolving trend in a network aspect.

In implementations, the AI/ML 234 may be implemented using any one or more of a variety of different public or proprietary machine learning models trained to evaluate and contribute to forecasting a possible failure prediction of a network aspect and/or an evolving trend of a network aspect. Machine learning models refer to a computer representation that can be tuned (e.g., trained) based on inputs to approximate unknown functions. In particular, machine learning models can utilize algorithms to learn from, and make predictions on, known data by analyzing the known data to learn to generate outputs that reflect patterns and attributes of the known data. For instance, a machine learning model can include decision trees, support vector machines, linear regression, logistic regression, Bayesian networks, random forest learning, dimensionality reduction algorithms, boosting algorithms, artificial neural networks, deep learning, and so forth.

The open RAN system 200 also includes an E2 interface 236, which is a logical interface connecting the near-RT RIC 202 with an E2 node of the O-RAN 5G 214. In implementations, the near-RT RIC 202 can be connected to multiple E2 nodes, via which performance data of KPIs is obtained by the near-RT RIC. The protocols over the E2 interface 236 are based on control plane protocols, and E2 services are grouped into categories, including near-RT RIC services (e.g., report, insert, control, and policy); near-RT RIC support functionalities, which include E2 interface management (e.g., E2 setup, E2 reset, reporting of general error situations, etc.); and near-RT RIC service update as capability exchange related to the list of E2 node services exposed over E2, etc.

The near-RT RIC 202 is an O-RAN network function (NF) that enables near real-time control and optimization of services and resources of E2 nodes via fine-grained data collection and actions over the E2 interface 236 with control loops in the order of ten (10) milliseconds (ms) to one second. The near-RT RIC 202 hosts the one or more xApps 224 that use the E2 interface 236 to collect near real-time information (e.g., on a UE basis or a cell basis) and provide value added services. The near-RT RIC control over the E2 nodes is guided via the policies and data received via the A1 interface 228 from the non-RT RIC 206. Based on the available data, the near-RT RIC 202 generates the RAN analytics information, which may then be exposed via a Y1 interface and/or transmitted to a NE or back to a UE via a wireless access point.

In aspects of the described techniques for risk forecasting in a wireless network, network aspects and features, including but not limited to, processing, signaling, efficiency, throughput, data rates, latency, connection density, reliability, mobility, energy efficiency, and/or any type of network operational resource usage may be monitored and evaluated by the disaster event forecasting entity 232 based on one or more KPIs 238. The KPIs 238 may include software-dependent KPIs, hardware-dependent KPIs, 5G and RIC KPIs, user-related KPIs (e.g., user satisfaction), environment conditions KPIs (e.g., temperature, humidity, energy stability, etc.), and/or any other type of KPIs related to or corresponding to network aspects and features.

In aspects of the described techniques, the disaster event forecasting entity 232, receives or obtains multiple series of KPI values over a time duration, where each series of the KPI values correspond to a respective KPI 238 that is a performance metric of a network aspect or feature. The disaster event forecasting entity 232 forecasts predicted KPI values of the respective KPIs based on the series of KPI values received over the time duration for a KPI. The disaster event forecasting entity 232 generates a KPI representation for each series of KPI values based on the predicted KPI value and one or more previous KPI values of the respective KPI. The disaster event forecasting entity 232 generates a FEM that includes the KPI representations of each KPI, and detects whether a change has occurred between the FEM and one or more previous FEMs over the time duration. In implementations, the disaster event forecasting entity 232 detects a similarity or a dissimilarity as the change between the FEM and the one or more previous FEMs over the time duration. In aspects of the described techniques, a dissimilarity between the FEM and the one or more previous FEMs forecasts a failure prediction of a network aspect, or forecasts an evolving trend in performance of a network aspect.

In implementations, the disaster event forecasting entity 232 normalizes a similarity metric or a dissimilarity metric, and generates a change rating as a normalized value of the similarity metric, the dissimilarity metric, or as the normalized value in a range between the similarity metric and the dissimilarity metric. A change rating may be a normalized value between zero (0) and one (1), such as a zero indicating either no change or a relatively low level of change between the FEM and the one or more previous FEMs for a KPI. Alternatively, a normalized value may be a one indicating a relatively high level of a change between the FEM and the one or more previous FEMs for a KPI. Alternatively, a normalized value may be a value between zero and one indicating at least the change between the FEM and the one or more previous FEMs for a KPI.

In various implementations, a risk assessment (e.g., a disaster risk for network operation) correlates to the change rating (e.g., a normalized value) between zero (0) and one (1). For example, a change rating of 25% or lower may indicate or forecast a relatively low risk; a change rating between 25% and 50% may indicate or forecast a low mean risk; a change rating between 50% and 75% may indicate or forecast a high mean risk; and a change rating 75% or higher may indicate or forecast a relatively high risk. In implementations, a forecasted risk assessment may be based on combined metrics that affect user satisfaction (e.g., throughput, latency, and data packet loss ratio for data transmission). Additionally, or alternatively, the forecasted risk assessment may be based on other factors that affect user satisfaction or quality of experience for wireless communications in a network (e.g., the wireless communications system).

FIG. 3 illustrates an example risk forecasting system 300 in accordance with aspects of the present disclosure. In this example, the risk forecasting system 300 includes a forecasting module 302 and risk evaluation 304 as a module, function, or component of the system. In aspects of the described techniques, a risk forecasting function 306 is implemented with a FSE 308 module, function, or component; an MTS 310 module, function, or component; and the risk evaluation 304 module, function, or component. In this example system, the forecasting module 302 includes the FSE 308 and the MTS 310 of the risk forecasting system 300.

In aspects of the described techniques, the FSE 308 of the risk forecasting function 306 receives or obtains multiple KPI series 312 of KPI values over a time duration, where each KPI series 312 of the KPI values correspond to a respective KPI (e.g., KPI 238 as shown and described with reference to FIG. 2) that is a performance metric of a network aspect or feature. The KPIs 238 may include software-dependent KPIs, hardware-dependent KPIs, 5G and RIC KPIs, user-related KPIs (e.g., user satisfaction), environment conditions KPIs (e.g., temperature, humidity, energy stability, etc.), and/or any other type of KPIs related to or corresponding to network aspects and features. In implementations, the network aspects and features may include, but is not limited to, processing, signaling, efficiency, throughput, data rates, latency, connection density, reliability, mobility, energy efficiency, and/or any type of network operational resource usage that may be monitored and evaluated by the risk forecasting function 306.

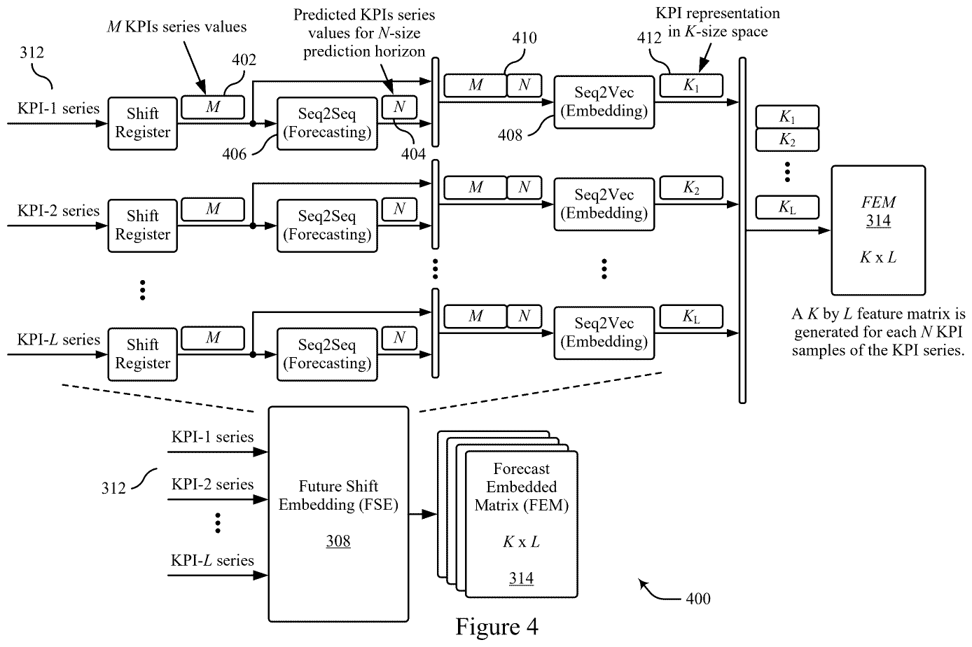

The risk forecasting function 306 forecasts predicted KPI values of the respective KPIs based on the KPI series 312 of the KPI values received over the time duration for a KPI. As further shown and described with reference to FIG. 4, the risk forecasting function 306 generates a KPI representation for each of the KPI series 312 of the KPI values based on the predicted KPI value and one or more previous KPI values of a respective KPI. The risk forecasting function 306 generates a FEM 314 that includes the KPI representations of each KPI. The FSE 308 generates the FEM 314 as K×L frames that represent a range of a KPI series 312, such as FEM₀, FEM₁, FEM₂, etc., as shown at 316. As indicated, a new FEM 314 may be generated every N samples of the KPI series 312. For example, the FSE 308 generate a new FEM 314 every 100 samples of a KPI (e.g., N=100). In implementations that utilize the AI/ML 234 to evaluate and contribute to forecasting a possible failure prediction and/or an evolving trend of a network aspect, the FEM 314 may be provided as a feedback into the system.

In aspects of the described techniques, the MTS 310 of the risk forecasting function 306 receives or obtains the FEM 314 and detects whether a change has occurred between the FEM and one or more previous FEMs over a time duration. In implementations, the risk forecasting function 306 detects a similarity or a dissimilarity as a change between the FEM 314 and the one or more previous FEMs over the time duration. A dissimilarity between the FEM and the one or more previous FEMs detected by the MTS 310 may forecast a failure prediction of a network aspect, or forecast an evolving trend in performance of a network aspect.

In implementations, the MTS 310 normalizes a similarity metric or a dissimilarity metric, and generates a change rating 318 as a normalized value of the similarity metric, the dissimilarity metric, or as the normalized value in a range between the similarity metric and the dissimilarity metric. A change rating 318 may be a normalized value between zero (0) and one (1), such as a zero indicating either no change or a relatively low level of change between the FEM 314 and the one or more previous FEMs for a KPI. Alternatively, a normalized value may be a one indicating a relatively high level of a change between the FEM 314 and the one or more previous FEMs for a KPI. Alternatively, a normalized value may be a value between zero and one indicating at least some level of change between the FEM 314 and the one or more previous FEMs for a KPI.

In aspects of the described techniques, the risk evaluation 304 of the risk forecasting function 306 assesses risk (e.g., a disaster risk for network operation) that correlates to the change rating 318 (e.g., a normalized value) between zero (0) and one (1). For example, a disaster risk percentage 320 of 25% or lower may indicate or forecast a relatively low risk; a change rating between 25% and 50% may indicate or forecast a low mean risk; a change rating between 50% and 75% may indicate or forecast a high mean risk; and a change rating 75% or higher may indicate or forecast a relatively high risk. In implementations, a forecasted risk assessment may be based on combined metrics that affect user satisfaction (e.g., throughput, latency, and data packet loss ratio for data transmission). Additionally, or alternatively, the forecasted risk assessment may be based on other factors that affect user satisfaction or quality of experience for wireless communications in a network (e.g., the wireless communications system).

As described above, an NE (e.g., any type of network equipment, network element, network function, network entity, and/or network node in the wireless communications system) implements the risk forecasting function 306 for risk forecasting in a wireless network. The risk forecasting function 306 represents functionality (e.g., logic, software, and/or hardware) enabling aspects of the described techniques for risk forecasting in a wireless network. The risk forecasting function 306 can be implemented as computer instructions stored on computer-readable storage media and can be executed by a processor system of the NE. Alternatively, or in addition, the risk forecasting function 306 can be implemented at least partially in hardware of the device.

In one or more implementations, the risk forecasting function 306 may include independent processing, memory, and/or logic components functioning as a computing and/or electronic device integrated with the NE. Alternatively, or in addition, the risk forecasting function 306 can be implemented in software, in hardware, or as a combination of software and hardware components. In this example, the risk forecasting function 306 is implemented as a software application or module, such as executable software instructions (e.g., computer-executable instructions) that are executable with a processor system of the NE to implement the techniques and features described herein. As a software application or module, the risk forecasting function 306 can be stored on computer-readable storage memory (e.g., memory of a device), or in any other suitable memory device or electronic data storage implemented with the function. Alternatively or in addition, the risk forecasting function 306 is implemented in firmware and/or at least partially in computer hardware. For example, at least part of the risk forecasting function 306 is executable by a computer processor, and/or at least part of the risk forecasting function 306 is implemented in logic circuitry.

FIG. 4 illustrates an example 400 of FSE implemented in the risk forecasting system 300, in accordance with aspects of the present disclosure. In this example 400, the FSE 308 is a module, function, or component of the risk forecasting function 306, as shown and described with reference to FIG. 3. The FSE 308 receives or obtains multiple KPI series 312 of KPI values (e.g., M KPIs series values 402) over a time duration, where each KPI series 312 of the KPI values 402 correspond to a respective KPI, which may be a performance metric of a network aspect or feature. The FSE 308 forecasts predicted KPI values 404 of the respective KPIs based on the series of KPI values 402 received over the time duration for respective KPIs utilizing sequence-to-sequence forecasting 406. A sequence-to-embedding feature 408 receives a KPI combination 410 of current KPI values 402 and the predicted KPI values 404, and generates a KPI vector representation 412 in K-size space. These aspects of forecasting, with time series analysis and embedding techniques from a combination of current and predicted future KPI information, provides for a holistic representation of individual KPIs and/or combinations of the KPIs. In implementations, the sequence-to-embedding feature 408 may be implemented as the AI/ML 234 to generate the KPI vector representations 412. The FSE 308 of the risk forecasting function 306 then generates a FEM 314 that includes the KPI representations of the KPIs.

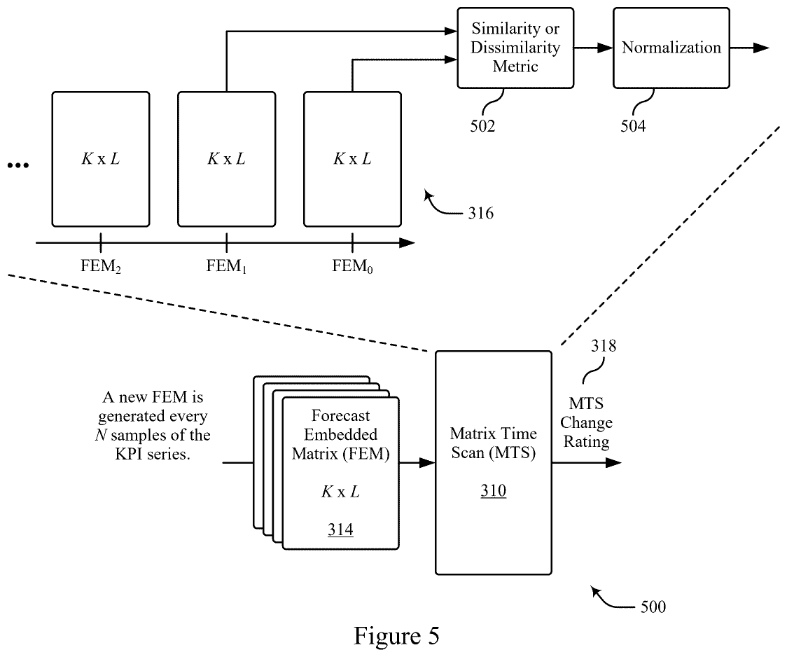

FIG. 5 illustrates an example 500 of MTS implemented in the risk forecasting system 300, in accordance with aspects of the present disclosure. In this example 500, the MTS 310 is a module, function, or component of the risk forecasting function 306, as shown and described with reference to FIG. 3. The MTS 310 detects a similarity or a dissimilarity (e.g., a similarity or dissimilarity metric 502) as the change between the FEM 314 and one or more previous FEMs over a time duration, for an evolutionary analysis of temporal trends of the KPIs. The similarity or dissimilarity metric 502 is detected based on the FEMs that are the current and future KPI representations of each KPI. This allows the MTS 310 to identify patterns, trends, and changes in the FEMs by comparing the representations of the KPIs at different times. In aspects of the described techniques, a dissimilarity between the FEM and the one or more previous FEMs forecasts a failure prediction of a network aspect, or forecasts an evolving trend in performance of a network aspect.

In implementations, the MTS 310 normalizes a similarity or dissimilarity metric 502 with a normalization function 504, and generates a change rating 318 as a normalized value of the similarity metric, the dissimilarity metric, or as the normalized value in a range between the similarity metric and the dissimilarity metric. As described above, a change rating 318 may be a normalized value between zero (0) and one (1), such as a zero indicating either no change or a relatively low level of change between the FEM 314 and the one or more previous FEMs for a KPI. Alternatively, a normalized value may be a one indicating a relatively high level of a change between the FEM 314 and the one or more previous FEMs for a KPI. Alternatively, a normalized value may be a value between zero and one indicating at least some level of change between the FEM 314 and the one or more previous FEMs for a KPI.

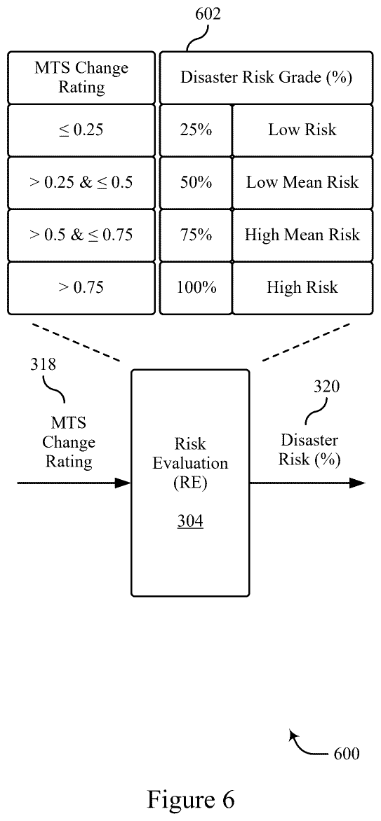

FIG. 6 illustrates an example 600 of risk evaluation implemented in the risk forecasting system 300, in accordance with aspects of the present disclosure. In this example 600, the risk evaluation 304 is a module, function, or component of the risk forecasting function 306, as shown and described with reference to FIG. 3. The risk evaluation 304 receives the input of the MTS change rating 318 and outputs the disaster risk percentage 320 (e.g., a quantified measure of risk expressed as a percentage). The disaster risk percentage 320 provides a value or representation of a possible severity of network risk associated with detected KPI changes. In implementations, a higher percentage indicates a greater risk of disaster or system failure, prompting preemptive actions or closer monitoring. This forecasting provides for early warnings about unusual events or potentially problematic conditions, allowing for more timely and effective mitigation due to proactive risk management in complex network systems.

As described above, and in one or more implementations, the risk evaluation 304 of the risk forecasting function 306 assesses risk (e.g., a disaster risk for network operation) that correlates to the change rating 318 (e.g., a normalized value) between zero (0) and one (1). As indicated at 602 for example, a disaster risk percentage of 25% or lower may indicate or forecast a relatively low risk; a change rating between 25% and 50% may indicate or forecast a low mean risk; a change rating between 50% and 75% may indicate or forecast a high mean risk; and a change rating 75% or higher may indicate or forecast a relatively high risk.

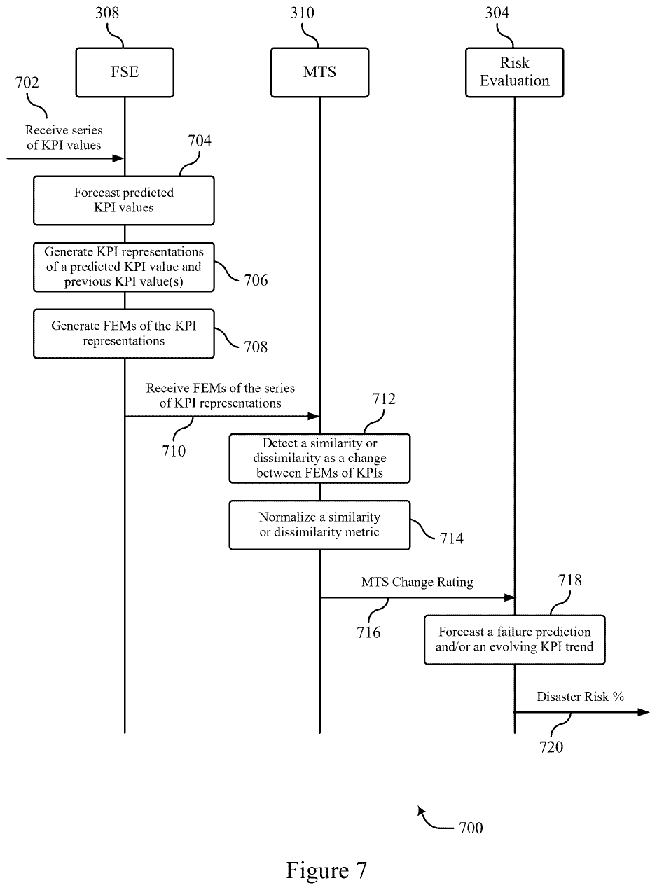

FIG. 7 illustrates an example signal diagram 700 of components of a risk forecasting function, module, or system in accordance with aspects of the present disclosure. For example, this signal diagram 700 includes the FSE 308, the MTS 310, and the risk evaluation 304 of the risk forecasting function 306. Reference is made herein to communicating data or information, such as signaling and/or communications that are provided, transmitted, obtained, and/or received between devices and/or function or module components. It is to be appreciated that other terms may be used interchangeably with communicating, such as signaling, transmitting, receiving, outputting, forwarding, retrieving, obtaining, and so forth.

At 702, the FSE 308 receives or obtains multiple KPI series 312 of KPI values 402 over a time duration, where each KPI series 312 of the KPI values correspond to a respective KPI that is a performance metric of a network aspect or feature. The KPIs may include software-dependent KPIs, hardware-dependent KPIs, 5G and RIC KPIs, user-related KPIs (e.g., user satisfaction), environment conditions KPIs (e.g., temperature, humidity, energy stability, etc.), and/or any other type of KPIs related to or corresponding to network aspects and features. In implementations, the network aspects and features may include, but is not limited to, processing, signaling, efficiency, throughput, data rates, latency, connection density, reliability, mobility, energy efficiency, and/or any type of network operational resource usage that may be monitored and evaluated by the risk forecasting function 306.

At 704, the FSE 308 forecasts predicted KPI values 404 of the respective KPIs based on the series of KPI values 402 received over the time duration for respective KPIs. At 706, the FSE 308 generates KPI representations of a predicted KPI value and previous one or more KPI values. For example, the FSE 308 generates a KPI representation for each of the KPI series 312 of the KPI values based on the predicted KPI value and one or more previous KPI values of a respective KPI. At 708, the FSE 308 generates the FEMs of the KPI representations.

At 710, the MTS 310 receives or obtains, from the FSE 308, the FEMs of the series of KPI representations. At 712, the MTS 310 detects similarity or dissimilarity as a change between FEMs of the KPIs, such as a change between a current (or recent) FEM 314 and the one or more previous FEMs over the time duration. A dissimilarity between the FEM and the one or more previous FEMs detected by the MTS 310 may forecast a failure prediction of a network aspect, or forecast an evolving trend in performance of a network aspect.

At 714, the MTS 310 normalizes a similarity or dissimilarity metric and generates a change rating 318 as a normalized value of the similarity metric, the dissimilarity metric, or as the normalized value in a range between the similarity metric and the dissimilarity metric. A change rating 318 may be a normalized value between zero (0) and one (1), such as a zero indicating either no change or a relatively low level of change between the FEM 314 and the one or more previous FEMs for a KPI. Alternatively, a normalized value may be a one indicating a relatively high level of a change between the FEM 314 and the one or more previous FEMs for a KPI. Alternatively, a normalized value may be a value between zero and one indicating at least some level of change between the FEM 314 and the one or more previous FEMs for a KPI.

At 716, the risk evaluation 304 receives or obtains, from the MTS 310, MTS change rating(s). At 718, the risk evaluation 304 forecasts a failure prediction and/or an evolving KPI trend, such as by assessing risk that correlates to the change rating. At 720, the risk evaluation 304 outputs or provides a disaster risk percentage. The risk evaluation 304 receives the input of the MTS change rating 318 and outputs the disaster risk percentage 320 (e.g., a quantified measure of risk expressed as a percentage). The disaster risk percentage 320 provides a value or representation of a possible severity of network risk associated with detected KPI changes. In implementations, a higher percentage indicates a greater risk of disaster or system failure, prompting preemptive actions or closer monitoring. This forecasting provides for early warnings about unusual events or potentially problematic conditions, allowing for more timely and effective mitigation due to proactive risk management in complex network systems.

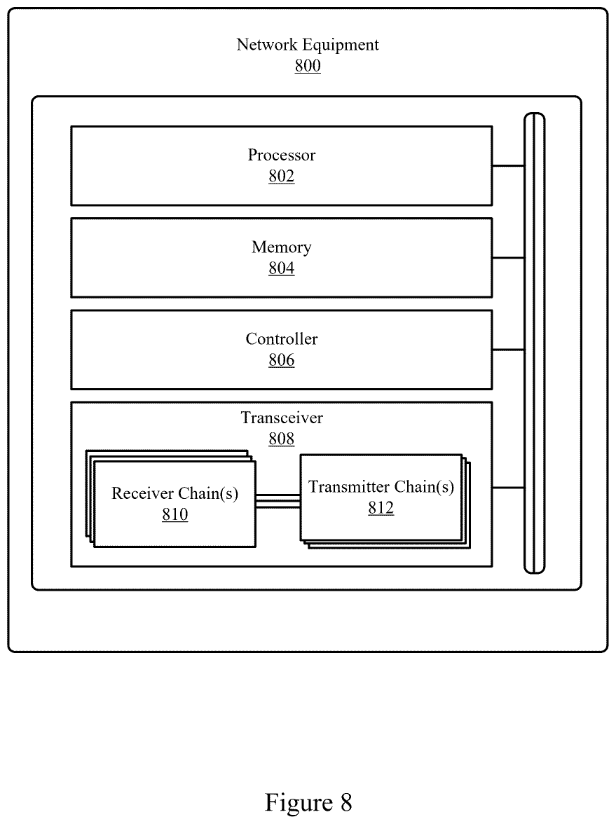

FIG. 8 illustrates an example of a NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such as the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. The NE 800 may be configured to or operable to support a means for receiving multiple series of KPI values over a time duration, each series of the KPI values corresponding to a respective KPI that is a performance metric of a network aspect; generating a KPI representation based at least in part on a predicted KPI value and one or more previous KPI values of the respective KPI, wherein a FEM includes the KPI representations of each KPI; and detecting whether a change has occurred between the FEM and one or more previous FEMs over the time duration.

Additionally, the NE 800 may be configured to or operable to support any one or combination of the method including forecasting predicted KPI values of respective KPIs based at least in part on the series of KPI values received over the time duration; generating the KPI representations of the respective KPIs; and generating the FEM of the KPI representations. The method including detecting at least one of a similarity or a dissimilarity as the change between the FEM and the one or more previous FEMs over the time duration. The method including utilizing machine learning to detect the at least one of the similarity or the dissimilarity as the change between the FEM and the one or more previous FEMs over the time duration. The dissimilarity between the FEM and the one or more previous FEMs forecasts a failure prediction of the network aspect. The dissimilarity between the FEM and the one or more previous FEMs forecasts an evolving trend in the performance of the network aspect. The method including normalizing at least one of a similarity metric or a dissimilarity metric; and generating a change rating as a normalized value of one of the similarity metric, the dissimilarity metric, or as the normalized value in a range between the similarity metric and the dissimilarity metric. The normalized value is one of a zero indicating at least one of no change or a relatively low level of change between the FEM and the one or more previous FEMs; a one indicating a relatively high level of change between the FEM and the one or more previous FEMs; or between the zero and the one indicating at least a change between the FEM and the one or more previous FEMs.

Additionally, or alternatively, the NE 800 may support at least one memory (e.g., the memory 804) and at least one processor (e.g., the processor 802) coupled with the at least one memory and configured to cause the NE to receive multiple series of KPI values over a time duration, each series of the KPI values corresponding to a respective KPI that is a performance metric of a network aspect; generate a KPI representation based at least in part on a predicted KPI value and one or more previous KPI values of the respective KPI, wherein a FEM includes the KPI representations of each KPI; and detect whether a change has occurred between the FEM and one or more previous FEMs over the time duration.

Additionally, the NE 800 may be configured to support any one or combination of the at least one processor is configured to cause a FSE of the risk forecasting function to forecast predicted KPI values of respective KPIs based at least in part on the series of KPI values received over the time duration; generate the KPI representations of the respective KPIs; and generate the FEM of the KPI representations. The at least one processor is configured to cause a MTS of the risk forecasting function to detect at least one of a similarity or a dissimilarity as the change between the FEM and the one or more previous FEMs over the time duration. The at least one processor is configured to cause the risk forecasting function to utilize machine learning to detect the at least one of the similarity or the dissimilarity as the change between the FEM and the one or more previous FEMs over the time duration. The dissimilarity between the FEM and the one or more previous FEMs forecasts a failure prediction of the network aspect. The dissimilarity between the FEM and the one or more previous FEMs forecasts an evolving trend in a performance of the network aspect. The at least one processor is configured to cause the MTS to normalize at least one of a similarity metric or a dissimilarity metric; and generate a change rating as a normalized value of one of the similarity metric, the dissimilarity metric, or as the normalized value in a range between the similarity metric and the dissimilarity metric. The normalized value is one of a zero indicating at least one of no change or a relatively low level of a change between the FEM and the one or more previous FEMs; a one indicating a relatively high level of a change between the FEM and the one or more previous FEMs; or between the zero and the one indicating at least the change between the FEM and the one or more previous FEMs.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas to receive a signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

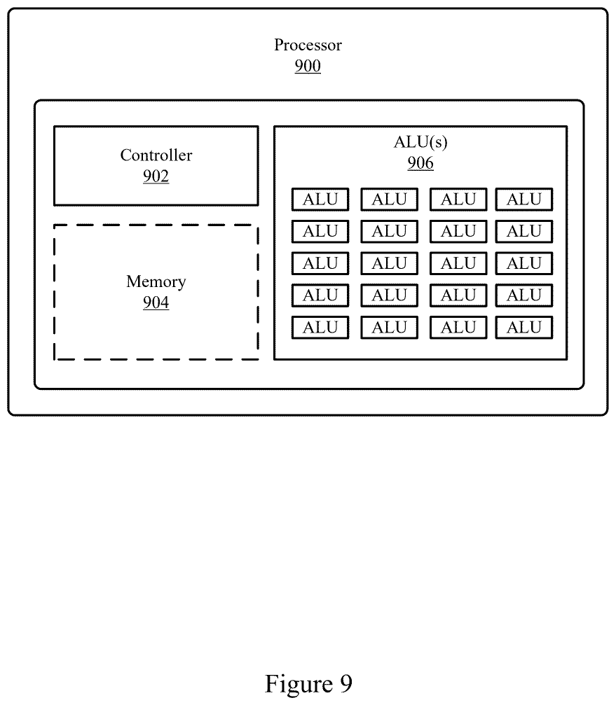

FIG. 9 illustrates an example of a processor 900 in accordance with aspects of the present disclosure. The processor 900 may be an example of a processor configured to perform various operations in accordance with examples as described herein. The processor 900 may include a controller 902 configured to perform various operations in accordance with examples as described herein. The processor 900 may optionally include at least one memory 904, which may be, for example, an L1/L2/L3 cache. Additionally, or alternatively, the processor 900 may optionally include one or more arithmetic-logic units (ALUs) 906. One or more of these components may be in electronic communication or otherwise coupled (e.g., operatively, communicatively, functionally, electronically, electrically) via one or more interfaces (e.g., buses).

The processor 900 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 900) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 902 may be configured to manage and coordinate various operations (e.g., signaling, receiving, obtaining, retrieving, transmitting, outputting, forwarding, storing, determining, identifying, accessing, writing, reading) of the processor 900 to cause the processor 900 to support various operations in accordance with examples as described herein. For example, the controller 902 may operate as a control unit of the processor 900, generating control signals that manage the operation of various components of the processor 900. These control signals include enabling or disabling functional units, selecting data paths, initiating memory access, and coordinating timing of operations.

The controller 902 may be configured to fetch (e.g., obtain, retrieve, receive) instructions from the memory 904 and determine subsequent instruction(s) to be executed to cause the processor 900 to support various operations in accordance with examples as described herein. The controller 902 may be configured to track memory addresses of instructions associated with the memory 904. The controller 902 may be configured to decode instructions to determine the operation to be performed and the operands involved. For example, the controller 902 may be configured to interpret the instruction and determine control signals to be output to other components of the processor 900 to cause the processor 900 to support various operations in accordance with examples as described herein. Additionally, or alternatively, the controller 902 may be configured to manage flow of data within the processor 900. The controller 902 may be configured to control transfer of data between registers, ALUs 906, and other functional units of the processor 900.

The memory 904 may include one or more caches (e.g., memory local to or included in the processor 900 or other memory, such as RAM, ROM, DRAM, SDRAM, SRAM, MRAM, flash memory, etc. In some implementations, the memory 904 may reside within or on a processor chipset (e.g., local to the processor 900). In some other implementations, the memory 904 may reside external to the processor chipset (e.g., remote to the processor 900).

The memory 904 may store computer-readable, computer-executable code including instructions that, when executed by the processor 900, cause the processor 900 to perform various functions described herein. The code may be stored in a non-transitory computer-readable medium such as system memory or another type of memory. The controller 902 and/or the processor 900 may be configured to execute computer-readable instructions stored in the memory 904 to cause the processor 900 to perform various functions. For example, the processor 900 and/or the controller 902 may be coupled with or to the memory 904, the processor 900, and the controller 902, and may be configured to perform various functions described herein. In some examples, the processor 900 may include multiple processors and the memory 904 may include multiple memories. One or more of the multiple processors may be coupled with one or more of the multiple memories, which may, individually or collectively, be configured to perform various functions herein.

The one or more ALUs 906 may be configured to support various operations in accordance with examples as described herein. In some implementations, the one or more ALUs 906 may reside within or on a processor chipset (e.g., the processor 900). In some other implementations, the one or more ALUs 906 may reside external to the processor chipset (e.g., the processor 900). One or more ALUs 906 may perform one or more computations such as addition, subtraction, multiplication, and division on data. For example, one or more ALUs 906 may receive input operands and an operation code, which determines an operation to be executed. One or more ALUs 906 may be configured with a variety of logical and arithmetic circuits, including adders, subtractors, shifters, and logic gates, to process and manipulate the data according to the operation. Additionally, or alternatively, the one or more ALUs 906 may support logical operations such as AND, OR, exclusive-OR (XOR), not-OR (NOR), and not-AND (NAND), enabling the one or more ALUs 906 to handle conditional operations, comparisons, and bitwise operations.

The processor 900 may support wireless communication in accordance with examples as disclosed herein. The processor 900 may be configured to or operable to support at least one controller (e.g., the controller 902) coupled with at least one memory (e.g., the memory 904) and configured to cause the processor to receive multiple series of KPI values over a time duration, each series of the KPI values corresponding to a respective KPI that is a performance metric of a network aspect; generate a KPI representation based at least in part on a predicted KPI value and one or more previous KPI values of the respective KPI, where a FEM includes the KPI representations of each KPI; and detect whether a change has occurred between the FEM and one or more previous FEMs over the time duration.

Additionally, the processor 900 may be configured to or operable to support any one or combination of the at least one controller is configured to cause the processor to forecast predicted KPI values of respective KPIs based at least in part on the series of KPI values received over the time duration; generate the KPI representations of the respective KPIs; and generate the FEM of the KPI representations. The at least one controller is configured to cause the processor to detect at least one of a similarity or a dissimilarity as the change between the FEM and the one or more previous FEMs over the time duration. The at least one controller is configured to cause the processor to utilize machine learning to detect the at least one of the similarity or the dissimilarity as the change between the FEM and the one or more previous FEMs over the time duration. The dissimilarity between the FEM and the one or more previous FEMs forecasts a failure prediction of the network aspect. The dissimilarity between the FEM and the one or more previous FEMs forecasts an evolving trend in a performance of the network aspect. The at least one controller is configured to cause the processor to normalize at least one of a similarity metric or a dissimilarity metric; and generate a change rating as a normalized value of one of the similarity metric, the dissimilarity metric, or as the normalized value in a range between the similarity metric and the dissimilarity metric. The normalized value is one of a zero indicating at least one of no change or a relatively low level of change between the FEM and the one or more previous FEMs; a one indicating a relatively high level of change between the FEM and the one or more previous FEMs; or between the zero and the one indicating at least a change between the FEM and the one or more previous FEMs.

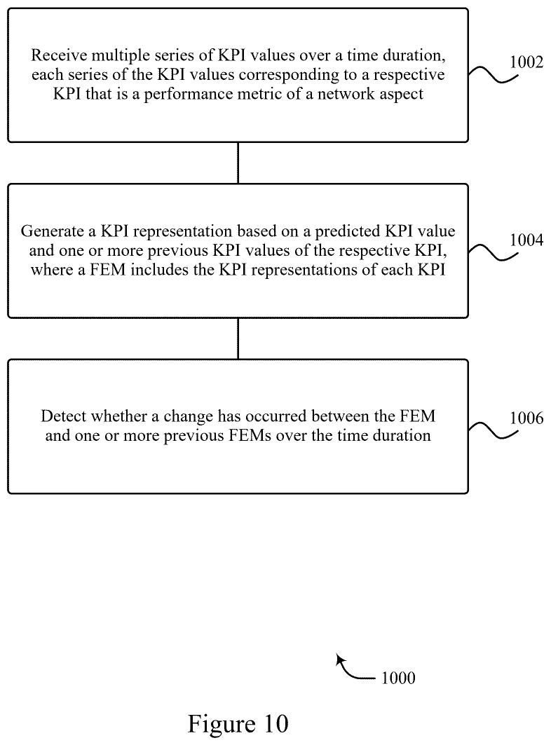

FIG. 10 illustrates a flowchart of a method 1000 in accordance with aspects of the present disclosure. The operations of the method may be implemented by a NE that implements a risk forecasting function, as described herein. In some implementations, the NE may execute a set of instructions to control the function elements of the NE and/or the risk forecasting function to perform the described functions. It should be noted that the method described herein describes a possible implementation, and that the operations and the steps may be rearranged or otherwise modified and that other implementations are possible.

At 1002, the method may include receiving multiple series of KPI values over a time duration, each series of the KPI values corresponding to a respective KPI that is a performance metric of a network aspect. The operations of 1002 may be performed in accordance with examples as described herein. In some implementations, aspects of the operations of 1002 may be performed by a NE as described with reference to FIG. 8.

At 1004, the method may include generating a KPI representation based on a predicted KPI value and one or more previous KPI values of the respective KPI, where a FEM includes the KPI representations of each KPI. The operations of 1004 may be performed in accordance with examples as described herein. In some implementations, aspects of the operations of 1004 may be performed by a NE as described with reference to FIG. 8.

At 1006, the method may include detecting whether a change has occurred between the FEM and one or more previous FEMs over the time duration. The operations of 1006 may be performed in accordance with examples as described herein. In some implementations, aspects of the operations of 1006 may be performed a NE as described with reference to FIG. 8.

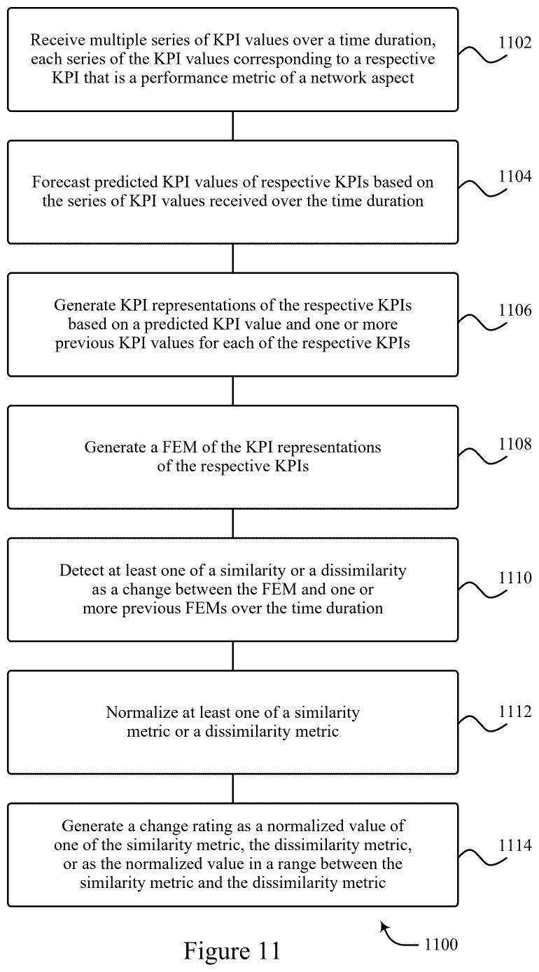

FIG. 11 illustrates a flowchart of a method 1100 in accordance with aspects of the present disclosure. The operations of the method may be implemented by a NE that implements a risk forecasting function, as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1102, the method may include receiving multiple series of KPI values over a time duration, each series of the KPI values corresponding to a respective KPI that is a performance metric of a network aspect. The operations of 1102 may be performed in accordance with examples as described herein. In some implementations, aspects of the operations of 1102 may be performed by a NE as described with reference to FIG. 8.

At 1104, the method may include forecasting predicted KPI values of respective KPIs based on the series of KPI values received over the time duration. The operations of 1104 may be performed in accordance with examples as described herein. In some implementations, aspects of the operations of 1104 may be performed by a NE as described with reference to FIG. 8.

At 1106, the method may include generating KPI representations of the respective KPIs based on a predicted KPI value and one or more previous KPI values for each of the respective KPIs. The operations of 1106 may be performed in accordance with examples as described herein. In some implementations, aspects of the operations of 1106 may be performed a NE as described with reference to FIG. 8.

At 1108, the method may include generating a FEM of the KPI representations of the respective KPIs. The operations of 1108 may be performed in accordance with examples as described herein. In some implementations, aspects of the operations of 1108 may be performed a NE as described with reference to FIG. 8.

At 1110, the method may include detecting at least one of a similarity or a dissimilarity as a change between the FEM and one or more previous FEMs over the time duration. The operations of 1114 may be performed in accordance with examples as described herein. In some implementations, aspects of the operations of 1114 may be performed a NE as described with reference to FIG. 8.

At 1112, the method may include normalizing at least one of a similarity metric or a dissimilarity metric. The operations of 1110 may be performed in accordance with examples as described herein. In some implementations, aspects of the operations of 1110 may be performed by a NE as described with reference to FIG. 8.

At 1114, the method may include generating a change rating as a normalized value of one of the similarity metric, the dissimilarity metric, or as the normalized value in a range between the similarity metric and the dissimilarity metric. The operations of 1112 may be performed in accordance with examples as described herein. In some implementations, aspects of the operations of 1112 may be performed a NE as described with reference to FIG. 8.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network equipment (NE) for wireless communication, comprising:
at least one memory; and
at least one processor coupled with the at least one memory and configured to cause a risk forecasting function to:
receive multiple series of key performance indicator (KPI) values over a time duration, each series of the KPI values corresponding to a respective KPI that is a performance metric of a network aspect;
generate a KPI representation based at least in part on a predicted KPI value and one or more previous KPI values of the respective KPI, wherein a forecast embedded matrix (FEM) includes the KPI representations of each KPI; and
detect whether a change has occurred between the FEM and one or more previous FEMs over the time duration.

2. The NE of claim 1, wherein the at least one processor is configured to cause a future shift embedding (FSE) of the risk forecasting function to:
forecast predicted KPI values of respective KPIs based at least in part on the series of KPI values received over the time duration;
generate the KPI representations of the respective KPIs; and
generate the FEM of the KPI representations.

3. The NE of claim 1, wherein the at least one processor is configured to cause a matrix time scan (MTS) of the risk forecasting function to detect at least one of a similarity or a dissimilarity as the change between the FEM and the one or more previous FEMs over the time duration.

4. The NE of claim 3, wherein the at least one processor is configured to cause the risk forecasting function to utilize machine learning to detect the at least one of the similarity or the dissimilarity as the change between the FEM and the one or more previous FEMs over the time duration.

5. The NE of claim 3, wherein the dissimilarity between the FEM and the one or more previous FEMs forecasts a failure prediction of the network aspect.

6. The NE of claim 3, wherein the dissimilarity between the FEM and the one or more previous FEMs forecasts an evolving trend in a performance of the network aspect.

7. The NE of claim 3, wherein the at least one processor is configured to cause the MTS to:
normalize at least one of a similarity metric or a dissimilarity metric; and
generate a change rating as a normalized value of one of the similarity metric, the dissimilarity metric, or as the normalized value in a range between the similarity metric and the dissimilarity metric.

8. The NE of claim 7, wherein the normalized value is one of:
a zero indicating at least one of no change or a relatively low level of a change between the FEM and the one or more previous FEMs;
a one indicating a relatively high level of a change between the FEM and the one or more previous FEMs; or
between the zero and the one indicating at least the change between the FEM and the one or more previous FEMs.

9. A processor, comprising:
at least one controller coupled with at least one memory and configured to cause the processor to:
receive multiple series of key performance indicator (KPI) values over a time duration, each series of the KPI values corresponding to a respective KPI that is a performance metric of a network aspect;
generate a KPI representation based at least in part on a predicted KPI value and one or more previous KPI values of the respective KPI, wherein a forecast embedded matrix (FEM) includes the KPI representations of each KPI; and
detect whether a change has occurred between the FEM and one or more previous FEMs over the time duration.

10. The processor of claim 9, wherein the at least one controller is configured to cause the processor to:
forecast predicted KPI values of respective KPIs based at least in part on the series of KPI values received over the time duration;
generate the KPI representations of the respective KPIs; and
generate the FEM of the KPI representations.

11. The processor of claim 9, wherein the at least one controller is configured to cause the processor to detect at least one of a similarity or a dissimilarity as the change between the FEM and the one or more previous FEMs over the time duration.

12. The processor of claim 11, wherein the at least one controller is configured to cause the processor to utilize machine learning to detect the at least one of the similarity or the dissimilarity as the change between the FEM and the one or more previous FEMs over the time duration.

13. The processor of claim 11, wherein the dissimilarity between the FEM and the one or more previous FEMs forecasts a failure prediction of the network aspect.

14. The processor of claim 11, wherein the dissimilarity between the FEM and the one or more previous FEMs forecasts an evolving trend in a performance of the network aspect.

15. The processor of claim 11, wherein the at least one controller is configured to cause the processor to:
normalize at least one of a similarity metric or a dissimilarity metric; and
generate a change rating as a normalized value of one of the similarity metric, the dissimilarity metric, or as the normalized value in a range between the similarity metric and the dissimilarity metric.

16. The processor of claim 15, wherein the normalized value is one of:
a zero indicating at least one of no change or a relatively low level of change between the FEM and the one or more previous FEMs;
a one indicating a relatively high level of change between the FEM and the one or more previous FEMs; or
between the zero and the one indicating at least a change between the FEM and the one or more previous FEMs.

17. A method performed by a network equipment (NE), the method comprising:
receiving multiple series of key performance indicator (KPI) values over a time duration, each series of the KPI values corresponding to a respective KPI that is a performance metric of a network aspect;
generating a KPI representation based at least in part on a predicted KPI value and one or more previous KPI values of the respective KPI, wherein a forecast embedded matrix (FEM) includes the KPI representations of each KPI; and
detecting whether a change has occurred between the FEM and one or more previous FEMs over the time duration.

18. The method of claim 17, further comprising:
forecasting predicted KPI values of respective KPIs based at least in part on the series of KPI values received over the time duration;
generating the KPI representations of the respective KPIs; and
generating the FEM of the KPI representations.

19. The method of claim 17, further comprising detecting at least one of a similarity or a dissimilarity as the change between the FEM and the one or more previous FEMs over the time duration.

20. The method of claim 19, further comprising:
normalizing at least one of a similarity metric or a dissimilarity metric; and
generating a change rating as a normalized value of one of the similarity metric, the dissimilarity metric, or as the normalized value in a range between the similarity metric and the dissimilarity metric.
